(19) United States
(12) Patent Application Publication
(10) Pub. No.: US 2022/0059280 A1
(43) Pub. Date: Feb. 24, 2022

(54) COIL COMPONENT

(71) Applicant: TDK CORPORATION, TOKYO (JP)

(72) Inventors: Keigo Higashida, Tokyo (JP); Hiroshi Suzuki, Tokyo (JP); Terumasa Toyoda, Tokyo (JP); Hanako Yoshino, Tokyo (JP)

(73) Assignee: TDK CORPORATION, TOKYO (JP)

(21) Appl. No.: 17/399,577

(22) Filed: Aug. 11, 2021

(30) Foreign Application Priority Data
Aug. 19, 2020 (JP) 2020-138350

(51) Int. Cl. H01F 27/29; H01F 27/255; H01F 27/28; H01F 17/06

(52) U.S. Cl. CPC H01F 27/292; H01F 17/062; H01F 27/2823; H01F 27/255

(57) ABSTRACT

Disclosed herein is a coil component that is surface-mountable on a substrate. The coil component includes a magnetic core, a wire wound around the magnetic core such that the coil axis direction is substantially parallel to the substrate, a terminal electrode connected to an end of the wire, and a low permeability part provided between the magnetic core and the terminal electrode. The low permeability part has a permeability lower than that of the magnetic core.

### BACKGROUND OF THE INVENTION

### Field of the Invention

The present invention relates to a coil component and, more particularly, to a coil component having a structure in which a wire is wound around a magnetic core made of ferrite or the like.

### Description of Related Art

JP 2007-095949A and JP 2013-187319A disclose a coil component having a structure in which a coil body combining an air-core coil and a magnetic core is mounted on a base member. However, in the coil component described in JP 2007-095949A and JP 2013-187319A, the use of the air-core coil complicates the manufacturing process. Further, the coil axis is perpendicular to the base member, so that a large amount of magnetic flux is applied to a terminal electrode and its corresponding land pattern formed on a substrate, which may easily cause an eddy current.

To solve such a problem, the coil axis is set parallel to the substrate by using a drum-shaped magnetic core as described in JP 2018-010990A. In the coil component described in JP 2018-010990A, a terminal electrode is provided on each of a pair of flange parts of the drum-shaped magnetic core.

However, in the coil component described in JP 2018-010990A, the terminal electrode is directly formed on the magnetic core, so that the amount of magnetic flux to be applied to the terminal electrode and its corresponding land pattern cannot be reduced to a sufficient level.

### SUMMARY

It is therefore an object of the present invention to, in a coil component whose axial direction is set parallel to a substrate, reduce an eddy current generated in a terminal electrode and its corresponding land pattern formed on the substrate.

A coil component according to the present invention is a coil component surface-mountable on a substrate and includes: a magnetic core; a wire wound around the magnetic core such that the coil axis direction is substantially parallel to the substrate; a terminal electrode connected to an end of the wire; and low permeability part provided between the magnetic core and the terminal electrode and having a permeability lower than that of the magnetic core.

According to the present invention, the low permeability part is provided between the magnetic core and terminal electrode, so that the amount of magnetic flux to be applied to the terminal electrodes decreases. This reduces an eddy current generated in the terminal electrodes and their corresponding land patterns formed on the substrate, allowing a reduction in heat generation of the terminal electrodes and land patterns.

In the present invention, the terminal electrodes may be fixed to the low permeability part. This can reliably reduce the amount of magnetic flux to be applied to the terminal electrodes and simplify the structure of the coil component.

In the present invention, the magnetic core may have a drum-shape having a winding core part wound with the wire and first and second flange parts formed at axial both ends of the winding core part, and the low permeability part may be fixed to each of the first and second flange parts. This allows a reduction in an eddy current in a surface-mountable coil component using a drum-shaped core. In this case, each low permeability part need not overlap the winding core part as viewed in the axis direction. This can suppress a reduction in inductance caused due to the presence of the low permeability part. Further, in this case, the coil component according to the present invention may further include a plate-like core fixed to the first and second flange parts and having a permeability higher than that of the low permeability part. This can further increase inductance. Further, in this case, the permeability μ′ of the low permeability part may be 100 or less. This can clearly reduce an eddy current.

As described above, according to the present invention, in a coil component whose axial direction is set parallel to a substrate, an eddy current generated in a terminal electrode and its corresponding land pattern formed on the substrate can be reduced.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic perspective view illustrating the outer appearance of a coil component 1 according to a first embodiment of the present invention;

FIG. 2 is a side view of the coil component 1 as viewed in the y-direction;

FIG. 3 is a schematic diagram for explaining a method for mounting the coil component 1 on a substrate 40;

FIG. 4 is a side view of a coil component 2 according to a second embodiment of the present invention as viewed in the y-direction;

FIG. 5 is a graph illustrating the relation between the height of the low permeability parts 21 and 22, inductance, and an eddy current loss;

FIG. 6 is a graph illustrating the relation between the permeability of a material constituting the low permeability parts 21 and 22, inductance, and eddy current loss;

FIG. 7 is a schematic view of the coil component 1 as viewed in the x-direction;

FIG. 8 is a cross-sectional view for explaining the structure of a coil component 3 according to a third embodiment of the present invention, in which the illustration of the wire W is omitted;

FIG. 9 is a cross-sectional view for explaining the structure of a coil component 4 according to a fourth embodiment of the present invention, in which the illustration of the wire W is omitted;

FIG. 10 is a cross-sectional view for explaining the structure of a coil component 5 according to a fifth embodiment of the present invention, in which the illustration of the wire W is omitted;

FIG. 11 is a side view of a coil component 6 according to a sixth embodiment of the present invention as viewed in the y-direction;

FIG. 12 is a schematic perspective view illustrating the outer appearance of coil component 7 according to a seventh embodiment of the present invention;

FIG. 13 is a schematic perspective view illustrating the outer appearance of coil component 8 according to an eighth embodiment of the present invention; and

FIG. 14 is a schematic perspective view illustrating the outer appearance of a coil component 9 according to a ninth embodiment of the present invention.

### DETAILED DESCRIPTION OF THE EMBODIMENTS

Preferred embodiments of the present invention will be explained below in detail with reference to the accompanying drawings.

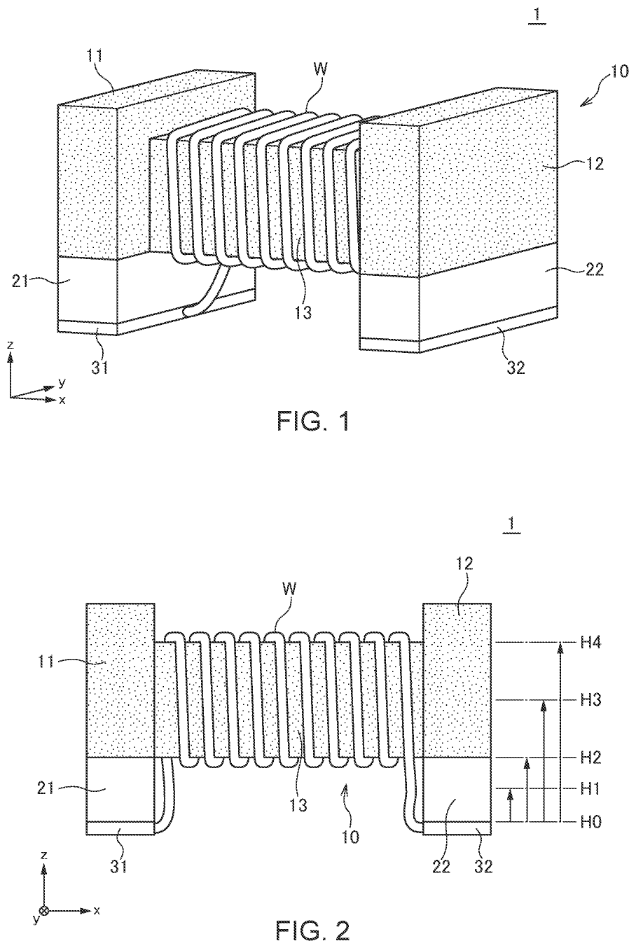

FIG. 1 is a schematic perspective view illustrating the outer appearance of a coil component 1 according to a first embodiment of the present invention. FIG. 2 is a side view of the coil component 1 as viewed in the y-direction.

As illustrated in FIGS. 1 and 2, the coil component 1 according to the first embodiment includes a drum-shaped magnetic core 10, a low permeability part 21 fixed to a first flange part 11 of the magnetic core 10, a low permeability part 22 fixed to a second flange part 12 of the magnetic core 10, a terminal electrode 31 fixed to the low permeability part 21, a terminal electrode 32 fixed to the low permeability part 22, and a wire W wound around a winding core part 13 of the magnetic core 10. The axis direction of the winding core part 13 is the x-direction, which is the arrangement direction of the terminal electrodes 31 and 32. One end of the wire W is connected to the terminal electrode 31, and the other end thereof is connected to the terminal electrode 32. The flange part 11 is provided at one end of the winding core part 13 in the x-direction, and the flange part 12 is provided at the other end in the x-direction. The magnetic core 10 is made of a magnetic material having a high permeability, such as Ni—Zn based ferrite.

The low permeability parts 21 and 22 are each a block made of a material having a permeability lower than that of the magnetic core 10. Specifically, a composite material obtained by dispersing metal magnetic particles in a resin binder or a non-magnetic material such as resin may be used. The low permeability parts 21, 22 can be fixed to the magnetic core 10 using an adhesive or the like. The low permeability part in the present embodiment is a block shaped material fixed to the magnetic core, and a non-block shaped material like an adhesive does not correspond to the low permeability part in the present invention, even if it is nonmagnetic. This is because adhesives can hardly provide the effect (to be described later) that would be provided by the low permeability part.

The terminal electrodes 31 and 32 may be a metal fitting made of a good conductor material such as copper, or may be obtained by directly baking silver paste or the like onto the low permeability parts 21 and 22. In the former case, the terminal electrodes 31, 32 and low permeability parts 21, 22 can be fixed using an adhesive or the like.

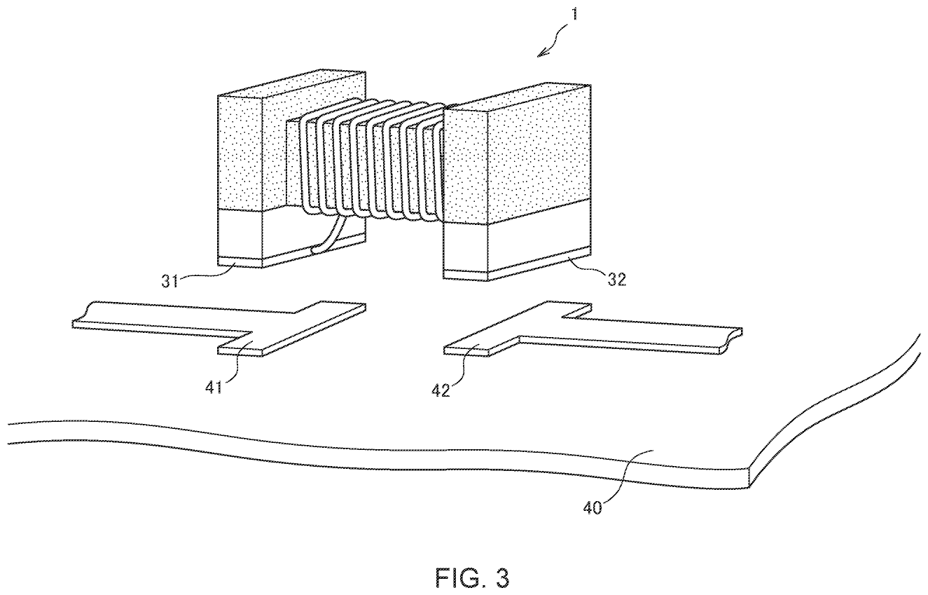

As illustrated in FIG. 3, the thus configured coil component 1 can be surface-mounted on a substrate 40 using a solder or the like such that land patterns 41 and 42 formed on the surface of the substrate 40 and the terminal electrodes 31 and 32 are electrically and mechanically connected respectively. In a state where the coil component 1 is mounted on the substrate 40, the coil axis of the coil component 1 is parallel to the substrate 40. Thus, the amount of magnetic flux to be applied to the terminal electrode and land pattern is reduced as compared to when a coil component having a coil axis perpendicular to the substrate is used.

In the coil component 1 according to the present embodiment, the low permeability parts 21 and 22 are provided between the magnetic core 10 and the terminal electrodes 31 and 32, so that a magnetic field generated by current flowing in the wire W is less likely to reach the terminal electrodes 31 and 32. That is, as compared to a coil component using a common drum-shaped core, the density of magnetic flux to be applied to the terminal electrodes 31, 32 and land patterns 41, 42 is lower, thus reducing an eddy current. This can reduce heat generation of the terminal electrode 31, 32 and land patterns 41, 42. In addition, when resin or a composite material is used as the material of the low permeability parts 21 and 22, the low permeability parts 21 and 22 function as a buffer, so that even when the coil component 1 mounted on the substrate 40 is coated with a moisture-proof coating, it is possible to make the fragile magnetic core 10 made of ferrite less likely to be broken due to the stress of the moisture-proof coating.

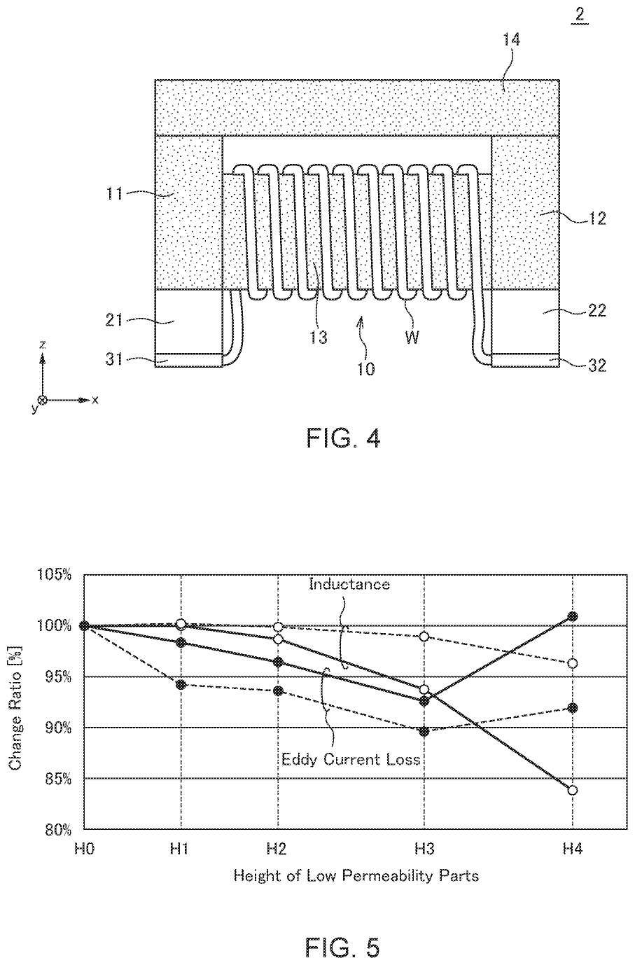

FIG. 4 is a side view of a coil component 2 according to a second embodiment of the present invention as viewed in the y-direction.

As illustrated in FIG. 4, the coil component 2 according to the second embodiment differs from the coil component 1 according to the first embodiment in that it further has a plate-like core 14 fixed to the flange parts 11 and 12. Other basic configurations are the same as those of the coil component 1 according to the first embodiment, so the same reference numerals are given to the same elements, and overlapping description will be omitted.

Like the magnetic core 10, the plate-like core 14 is made of a magnetic material having a high permeability, such as Ni—Zn based ferrite, and is fixed to the flange parts 11 and 12 using an adhesive or the like to form a closed loop magnetic path. That is, the low permeability parts 21 and 22 are fixed to the lower side of the magnetic core 10, and the plate-like core 14 is fixed to the upper side of the magnetic core 10. The plate-like core 14 and the magnetic core 10 may not necessarily be made of the same magnetic material; however, when a material having a higher permeability than at least a material constituting the low permeability parts 21 and 22 is used for the plate-like core 14, inductance can be significantly increased.

FIG. 5 is a graph illustrating the relation between the height of the low permeability parts 21 and 22, inductance, and an eddy current loss. The change rates of the inductance and eddy current loss are represented as relative values with those obtained when the low permeability parts 21 and 22 are not present defined as a reference value (=100%).

Symbols H1 to H4 in FIG. 5 each denote the z-direction height of the low permeability parts 21 and 22 based on the z-direction height H0 of the terminal electrodes 31 and 32 illustrated in FIG. 2. The height H2 denotes the position of the lower surface of the winding core part 13, and the height H4 denotes the position of the upper surface of the winding core part 13. The height H1 denotes the intermediate position between the heights H0 and H2, and the height H3 denotes the intermediate position between the heights H2 and H4. The dashed line in FIG. 5 represents the characteristics of the coil component 1 according to the first embodiment having no plate-like core 14, and the solid line represents the characteristics of the coil component 2 according to the second embodiment having the plate-like core 14.

The graph of FIG. 5 reveals that as the height (thickness in the z-direction) of the low permeability parts 21 and 22 increases, the inductance decreases, but the eddy current loss also decreases as a whole. However, when the height of the low permeability parts 21 and 22 reaches H4, the inductance significantly decreases, and the eddy current loss increases more than when the height of the low permeability parts 21 and 22 is H3. This is because that when the height of the low permeability parts 21 and 22 reaches H4, the end surfaces (yz surfaces) of the winding core part 13 in the x-direction are completely covered with the low permeability parts 21 and 22. On the other hand, when the height of the low permeability parts 21 and 22 is limited to H2, a reduction in the inductance can be suppressed to a slight extent, and the eddy current loss clearly decreases. Further, when the height of the low permeability parts 21 and 22 is limited to H1, the eddy current loss clearly decreases without a substantial decrease in the inductance.

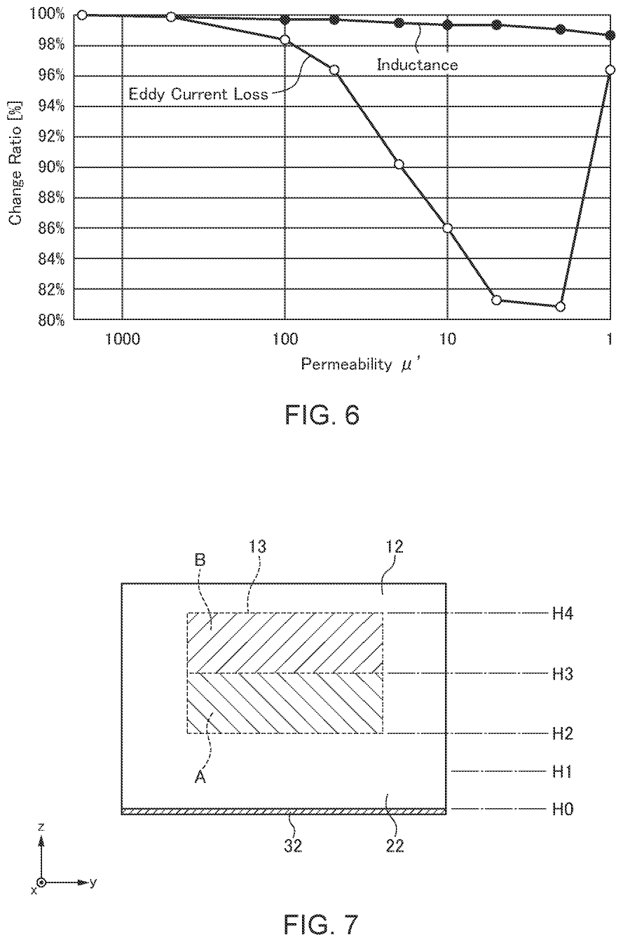

FIG. 6 is a graph illustrating the relation between the permeability of a material constituting the low permeability parts 21 and 22, inductance, and eddy current loss. The change rates of the inductance and eddy current loss are represented as relative values with those obtained when the permeability of the low permeability parts 21 and 22 are equal to the permeability (μ′=1800) of the magnetic core 10 defined as a reference value (=100%).

The graph of FIG. 6 reveals that when the permeability μ′ of the magnetic core 10 is 1800, the eddy current loss hardly decreases at a permeability μ′ of about 500 of the low permeability parts 21 and 22. When the permeability μ′ of the low permeability parts 21 and 22 is 100 or less, the effect of a reduction in the eddy current loss is exhibited. Further, when the permeability μ′ of the low permeability parts 21 and 22 is 10 or less, the reduction effect of the eddy current loss becomes conspicuous. On the other hand, the inductance slightly decreases as the permeability μ′ of the low permeability parts 21 and 22 decreases, but its decreased amount is extremely small.

FIG. 7 is a schematic view of the coil component 1 as viewed in the x-direction.

As illustrated in FIG. 7, when the height of the low permeability parts 21 and 22 is H2 or less, the low permeability parts 21, 22 and the winding core part 13 do not overlap as viewed in the x-direction, so that magnetic flux passing through the winding core part 13 is hardly blocked by the low permeability parts 21 and 22. On the other hand, when the height of the low permeability parts 21 and 22 is H3, the lower half area A of the end surface of the winding core part 13 overlaps the low permeability parts 21 and 22. Even in this case, magnetic flux passing through the winding core part 13 mainly passes the upper half area B of the end surface of the winding core part 13, a reduction in the inductance can be suppressed sufficiently. However, when the height of the low permeability parts 21 and 22 reaches H4, all the area (areas A and B) of the end surface of the winding core part overlaps the low permeability parts 21 and 22, the inductance significantly decreases. In view of the above, it is preferable to design the size and position of the low permeability parts 21 and 22 so as to prevent the upper half area B of the end surface of the winding core part 13 from being covered with the low permeability parts 21 and 22.

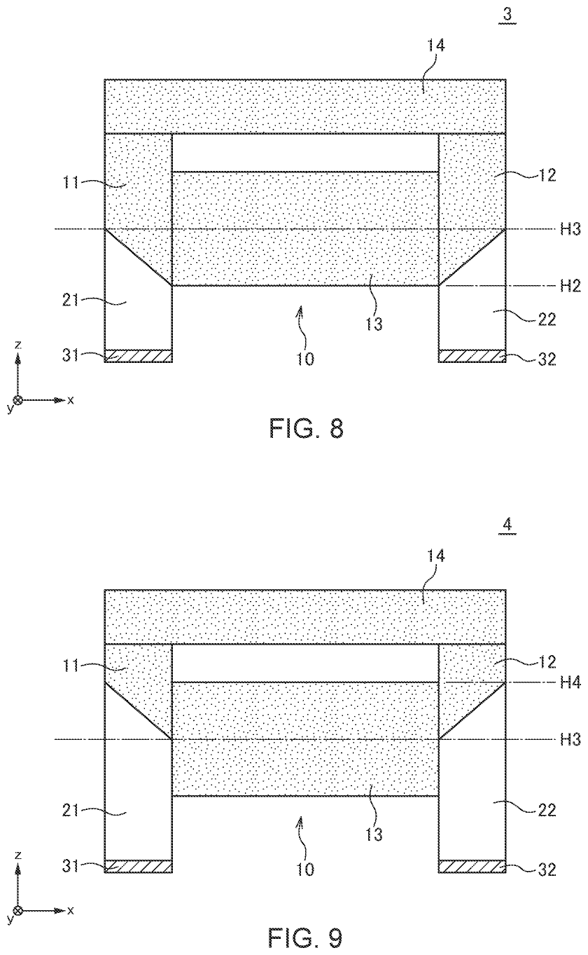

FIG. 8 is a cross-sectional view for explaining the structure of a coil component 3 according to a third embodiment of the present invention, in which the illustration of the wire W is omitted.

In the coil component 3 illustrated in FIG. 8, the boundary between the magnetic core 10 and the low permeability parts 21 and 22 is inclined, and thus, the low permeability parts 21 and 22 decrease in height toward the winding core part 13. Specifically, the height of the low permeability parts 21 and 22 at the end surface (yz surface) of the flange parts 11 and 12 in the x-direction is H3, whereas the height of the low permeability parts 21 and 22 at the end surface (yz surface) of the winding core part 13 in the x-direction is H2. Thus, even when the low permeability parts 21, 22 and winding core part 13 partially overlap as viewed in the x-direction, it is possible to further reduce the eddy current loss while suppressing a reduction in the inductance by inclining the boundary between the magnetic core 10 and the low permeability parts 21, 22 along the direction of magnetic flux.

FIG. 9 is a cross-sectional view for explaining the structure of a coil component 4 according to a fourth embodiment of the present invention, in which the illustration of the wire W is omitted.

In the coil component 4 illustrated in FIG. 9 as well, the boundary between the magnetic core 10 and the low permeability parts 21 and 22 is inclined, and thus, the low permeability parts 21 and 22 decrease in height toward the winding core part 13. Specifically, the height of the low permeability parts 21 and 22 at the end surface (yz surface) of the flange parts 11 and 12 in the x-direction is H4, whereas the height of the low permeability parts 21 and 22 at the end surface (yz surface) of the winding core part 13 in the x-direction is H3. Thus, even when the low permeability parts 21, 22 and winding core part 13 completely overlap as viewed in the x-direction, it is possible to further reduce the eddy current loss while suppressing a reduction in the inductance by inclining the boundary between the magnetic core 10 and the low permeability parts 21, 22 along the direction of magnetic flux.

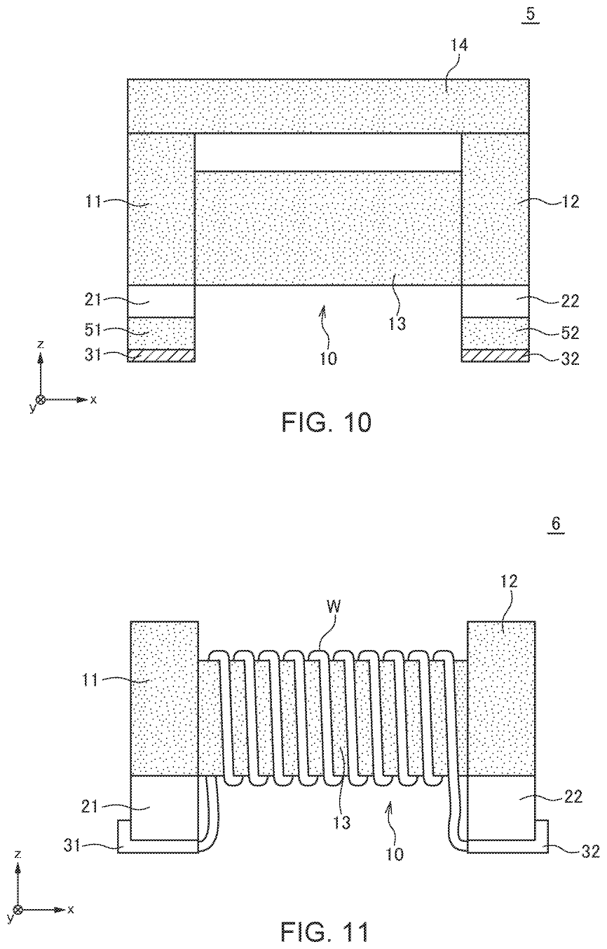

FIG. 10 is a cross-sectional view for explaining the structure of a coil component 5 according to a fifth embodiment of the present invention, in which the illustration of the wire W is omitted.

The coil component 5 illustrated in FIG. 10 differs from the coil component 2 according to the second embodiment in the following respects: a high permeability part 51 is provided between the flange part 11 and the low permeability part 21; a high permeability part 52 is provided between the flange part 12 and the low permeability part 22; and the terminal electrodes 31 and 32 are fixed respectively to the high permeability parts 51 and 52. The high permeability parts 51 and 52 are made of a material having a higher permeability than the low permeability parts 21 and 22. The high permeability parts 51 and 52 may be formed as a part of the magnetic core 10. As exemplified by the coil component 5 according to the fifth embodiment, the terminal electrode may not necessarily be directly fixed to the low permeability part, but it suffices that the low permeability part is interposed between the magnetic core and the terminal electrode.

FIG. 11 is a side view of a coil component 6 according to a sixth embodiment of the present invention as viewed in the y-direction.

As illustrated in FIG. 11, the coil component 6 according to the sixth embodiment differs from the coil component 1 according to the first embodiment in that the terminal electrodes 31 and 32 have an L shape and not only cover the xy bottom surfaces of the low permeability parts 21 and 22, but also partially cover the yz outer surfaces thereof. As exemplified by the coil component 6 according to the present embodiment, the shape of the terminal electrode is not particularly limited in the present invention.

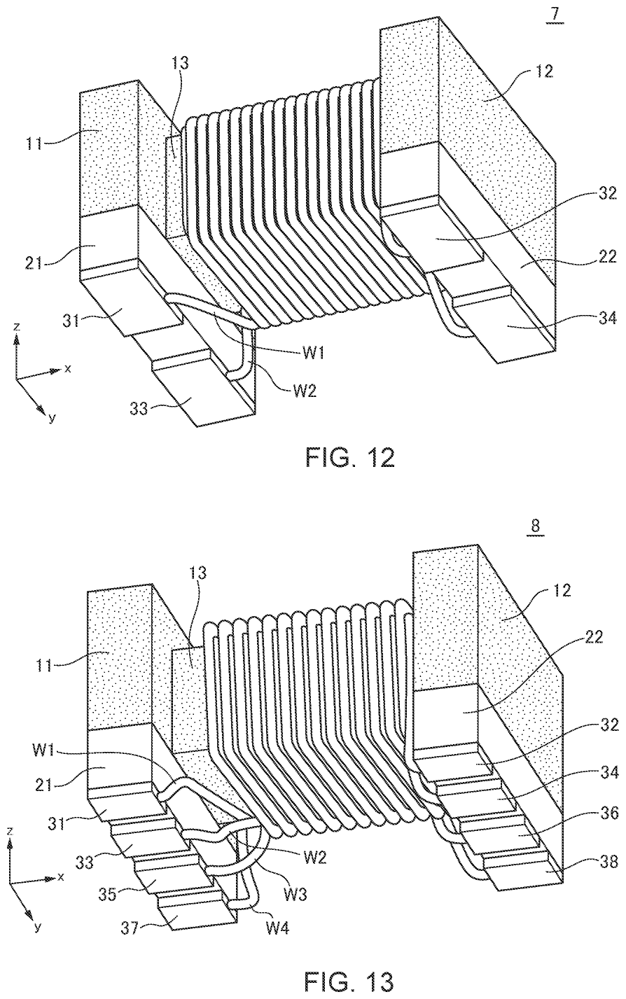

FIGS. 12 and 13 are schematic perspective views illustrating the outer appearances of coil components 7 and 8 according to seventh and eighth embodiments of the present invention.

As illustrated in FIG. 12, the coil component 7 according to the seventh embodiment differs from the coil component 1 according to the first embodiment in that two wires W1 and W2 are wound around the winding core part 13, and, accordingly, four terminal electrodes 31 to 34 are provided. Both ends of the wire W2 are connected respectively to the terminal electrodes 33 and 34. Further, as illustrated in FIG. 13, the coil component 8 according to the eighth embodiment differs from the coil component 1 according to the present embodiment in that four wires W1 to W4 are wound around the winding core part 13, and, accordingly, eight terminal electrodes 31 to 38 are provided. Both ends of the wire W3 are connected respectively to the terminal electrodes 35 and 36, and both ends of the wire W4 are connected respectively to the terminal electrodes 37 and 38. As exemplified by the coil components 7 and 8 according to the seventh and eighth embodiments, the number of the wires and the number of the terminal electrodes are not particularly limited in the present invention.

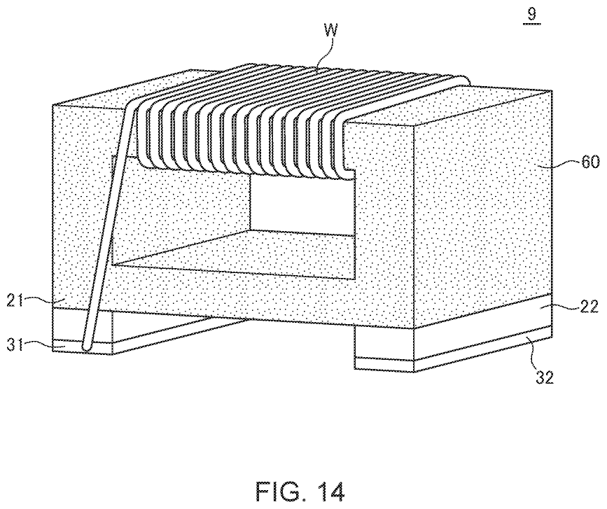

FIG. 14 is a schematic perspective view illustrating the outer appearance of a coil component 9 according to a ninth embodiment of the present invention.

As illustrated in FIG. 14, the coil component 9 according to the ninth embodiment differs from the coil component 1 according to the first embodiment in that it uses a magnetic core 60 having a toroidal shape. In the present embodiment, the low permeability parts 21 and 22 are fixed to the xy bottom surface of the magnetic core 60, and the terminal electrodes 31 and 32 are fixed respectively to the low permeability parts 21 and 22, thereby enabling surface mounting. As exemplified by the coil component 9 according to the present embodiment, the shape of the magnetic core is not particularly limited in the present invention.

It is apparent that the present invention is not limited to the above embodiments, but may be modified and changed without departing from the scope and spirit of the invention.

What is claimed is:

1. A coil component that is surface-mountable on a substrate, the coil component comprising:
a magnetic core;
a wire wound around the magnetic core such that the coil axis direction is substantially parallel to the substrate;
a terminal electrode connected to an end of the wire; and
a low permeability part provided between the magnetic core and the terminal electrode,
wherein the low permeability part has a permeability lower than that of the magnetic core.

2. The coil component as claimed in claim 1, wherein the terminal electrode is fixed to the low permeability part.

3. The coil component as claimed in claim 1,
wherein the magnetic core has a drum-shape having a winding core part wound with the wire and first and second flange parts formed at axial both ends of the winding core part, and
wherein the low permeability part is fixed to each of the first and second flange parts.

4. The coil component as claimed in claim 3, wherein the low permeability part does not overlap the winding core part as viewed in the axis direction.

5. The coil component as claimed in claim 4, further comprising a plate-like core fixed to the first and second flange parts,
wherein the plate-like core has a permeability higher than that of the low permeability part.

6. The coil component as claimed in claim 5, wherein a permeability μ′ of the low permeability part is 100 or less.

7. A coil component comprising:
a magnetic core including a first part, a second part, a third part connecting one end of the first part to one end of the second part, and a fourth part connecting other end of the first part to other end of the second part;
a wire wound around the first part of the magnetic core;
a first terminal electrode connected to one end of the wire;
a second terminal electrode connected to other end of the wire;
a first block member arranged between the third part of the magnetic core and the first terminal electrode; and
a second block member arranged between the fourth part of the magnetic core and the second terminal electrode,
wherein each of the first and second block members has a permeability lower than that of the magnetic core.

8. The coil component as claimed in claim 7, wherein the first, third, and fourth parts of the magnetic core have a monolithic construction.

9. The coil component as claimed in claim 8, wherein the second part of the magnetic core is fixed to the third and fourth parts of the magnetic core.

10. The coil component as claimed in claim 7, wherein the magnetic core has a toroidal shape.

11. The coil component as claimed in claim 7, wherein each of the first and second block members is adhered to the magnetic core by an adhesive.

12. The coil component as claimed in claim 7, wherein each of the first and second block members comprises an non-magnetic material.

13. The coil component as claimed in claim 12, wherein each of the first and second block members comprises resin.

14. The coil component as claimed in claim 7, wherein each of the first and second block members does not overlap the first part of the magnetic core as viewed in an axis direction of the first part of the magnetic core.

15. The coil component as claimed in claim 7, wherein each of the first and second block members partially overlaps the first part of the magnetic core as viewed in an axis direction of the first part of the magnetic core.

16. The coil component as claimed in claim 7, wherein a permeability μ′ of the first and second block members is 100 or less.
